(19) United States
(12) Patent Application Publication
(10) Pub. No.: US 2025/0207338 A1
(43) Pub. Date: Jun. 26, 2025

(54) ELECTRO-HYDRAULIC DRIVE SYSTEM

(71) Applicant: Hamm AG, Tirschenreuth (DE)

(72) Inventors: Thomas KLEIN, Mitterteich (DE); Detlef BORNEMANN, Leonberg (DE)

(21) Appl. No.: 18/987,032

(22) Filed: Dec. 19, 2024

(30) Foreign Application Priority Data
Dec. 20, 2023 (DE) DE102023135899.5

(51) Int. Cl. E01C 19/28

(52) U.S. Cl. CPC E01C 19/282

(57) ABSTRACT

An electro-hydraulic drive system for a ground processing machine with at least one drive roller comprises at least one hydraulic traction pump (P₁, P₂) that can be driven by a drive electric motor (E₁, E₂) for conveying hydraulic fluid, at least two hydraulic traction motors (M₁, M₂, M₃, M₄) that are to be fed with hydraulic fluid by means of the at least one hydraulic traction pump (P₁, P₂), a valve arrangement (26), wherein the valve arrangement (26) comprises at least one switching valve unit (S₁, S₂, S₃, S₄) in association with each hydraulic traction motor (M₁, M₂, M₃, M₄), a control unit (28) for operating the valve arrangement (26) in such a way that in a basic drive state each hydraulic traction motor (M₁, M₂, M₃, M₄) is fed with hydraulic fluid from the at least one hydraulic traction pump (P₁, P₂) to generate a drive torque and in a high-pressure drive state at least one hydraulic traction motor (M₁, M₂, M₃, M₄) is not fed with hydraulic fluid from the at least one hydraulic traction pump (P₁, P₂) to generate a drive torque.

The present invention relates to an electro-hydraulic drive system for a ground processing machine, for example a ground compactor, with at least one drive roller.

Ground processing machines designed as ground compactors can, for example, comprise, as drive rollers, two ground processing rollers, in particular compactor rollers, arranged one after the other in a longitudinal direction of the ground compactor and rotatable about mutually parallel axes of rotation. Both ground processing rollers, each providing a drive roller, can be driven by an electro-hydraulic drive system to rotate about the respective associated axis of rotation. In association with each ground processing roller, the electro-hydraulic drive system may comprise one or two hydraulic traction motors, each fed in pairs or together with hydraulic fluid by one or more hydraulic traction pumps to generate a drive torque.

It is the object of the present invention to provide an electro-hydraulic drive system for a ground processing machine, a ground processing machine constructed with such an electro-hydraulic drive system and a method for operating such a ground processing machine, with which a high efficiency in the utilization of the electrical energy used for the drive is achieved.

According to the invention, this object is achieved by an electro-hydraulic drive system for a ground processing machine with at least one drive roller, comprising:
at least one hydraulic traction pump which can be driven by a drive electric motor for pumping hydraulic fluid,
at least two hydraulic traction motors to be fed with hydraulic fluid by means of the at least one hydraulic traction pump,
a valve arrangement,
a control unit for operating or controlling the valve arrangement such that in a basic drive state each hydraulic traction motor is fed with hydraulic fluid from the at least one hydraulic traction pump to generate a drive torque and in a high-pressure drive state at least one hydraulic traction motor is not fed with hydraulic fluid from the at least one hydraulic traction pump to generate a drive torque.

The present invention utilizes the knowledge that an increase in efficiency in hydraulic drive systems can be achieved if the pressure level of the hydraulic pressure is increased. In order to achieve an increase in the pressure level, the electro-hydraulic drive system constructed according to the invention is designed to deactivate or depressurize individual hydraulic traction motors that are fed with hydraulic fluid in parallel. The pressure level for the hydraulic traction motor(s) that are still fed with hydraulic fluid to generate drive torque is increased accordingly so that they can be operated with greater efficiency. The higher efficiency of the hydraulic traction motors, which are still fed with hydraulic fluid to generate a drive torque, overcompensates for flow losses in the deactivated or depressurized hydraulic traction motors.

A transition into such a state, in which only a portion of the hydraulic traction motors are fed with hydraulic fluid to generate a drive torque, can occur, for example, when working at a main operating point, for example when a ground compactor is used to compact asphalt behind an asphalt paver on a substantially horizontal surface. In this state, for example, only one of two compactor rollers that are basically used as drive roller can be driven to rotate, or only one of the two hydraulic traction motors assigned to each of the two compactor rollers can be used to generate a drive torque.

In order to supply the various hydraulic traction motors with hydraulic fluid, it is proposed that at least one hydraulic circuit is provided with at least two hydraulic traction motors fed with hydraulic fluid in parallel by at least one hydraulic traction pump, and that the valve arrangement comprises at least one switching valve unit in association with the at least two hydraulic traction motors of at least one hydraulic traction circuit.

In order to suitably condition the hydraulic traction motors for the various operating modes, when the at least one switching valve unit assigned to a hydraulic traction motor is switched to a basic drive state switching position, hydraulic fluid delivered by the at least one hydraulic traction pump can be fed to this hydraulic traction motor to generate a drive torque, and when the at least one switching valve unit assigned to a hydraulic traction motor is switched to a high-pressure drive state switching position, a bypass flow path assigned to this hydraulic traction motor and parallel to it can be open for flow- through and/or generate a flow short circuit between two fluid connections of the hydraulic traction motor.

In a particularly advantageous embodiment for switching the hydraulic traction motors between an active and an inactive state, at least two hydraulic traction circuits can be provided, each hydraulic traction circuit being assigned a hydraulic traction pump and at least two hydraulic traction motors fed with hydraulic fluid in parallel by the hydraulic traction pump.

Each hydraulic traction pump can be assigned an electric drive motor so that each hydraulic traction pump can be operated independently of other hydraulic traction pumps by its individually assigned electric drive motor.

For a simple design of the valve arrangement, this can comprise a switching valve unit in each of the hydraulic traction circuits assigned to each hydraulic traction motor, which shuts off the bypass flow path parallel to this in the basic drive state switching position and releases it for flow-through in the high-pressure drive state switching position.

In an alternative design, at least one hydraulic traction circuit can be provided in the electro-hydraulic drive system, wherein the at least one hydraulic traction circuit is assigned a hydraulic traction pump and at least two, preferably at least four hydraulic traction motors fed in parallel with hydraulic fluid by the hydraulic traction pump.

When the electro-hydraulic drive system is constructed with one or a single hydraulic traction circuit, the valve arrangement associated with each hydraulic traction motor can comprise a switching valve unit that blocks the bypass flow path parallel to it in the basic drive state switching position and releases it for flow in the high-pressure drive state switching position.

In order to achieve greater variability when activating or deactivating the hydraulic traction motors, it is proposed that the hydraulic traction motors form at least two hydraulic traction motor groups fed in parallel by the hydraulic traction pump, each with at least two hydraulic traction motors fed in parallel by the hydraulic traction pump, wherein the valve arrangement associated with each hydraulic traction motor group comprises at least one shut-off valve unit for selectively blocking this hydraulic traction motor group against the supply of hydraulic fluid delivered by the hydraulic traction pump and releasing this hydraulic traction motor group for the supply of hydraulic fluid delivered by the hydraulic traction pump.

In this case, for the defined coupling or uncoupling of individual hydraulic traction motor groups, the valve arrangement associated with each hydraulic traction motor group can comprise two shut-off valve units arranged on both sides of this hydraulic traction motor group in the direction of fluid flow.

In a further alternative embodiment, the valve arrangement can comprise two switching valve units associated with each hydraulic traction motor, wherein in the basic drive state switching position the switching valve units associated with a respective hydraulic traction motor release the supply of hydraulic fluid delivered by the hydraulic traction pump to this hydraulic traction motor and in the high-pressure drive state switching position release the bypass flow path parallel to this hydraulic traction motor to generate the flow short circuit between the fluid connections of this hydraulic traction motor.

In order to be able to switch one or more hydraulic traction motors on or off during operation, i.e. when fluid pressure is present, it is proposed that at least one, preferably every switching valve unit is designed as a proportional valve. The ability to switch on one or more hydraulic traction motors during driving is particularly advantageous if they are also to be used to generate a braking torque if necessary.

The object stated at the outset is further achieved by a ground processing machine, preferably a ground compactor, comprising at least one drive roller and an electro-hydraulic drive system constructed according to the invention.

Depending on the intended use of a particular ground processing machine, at least one, preferably each drive roller may comprise a ground processing roller. It can also be provided that at least one drive roller comprises at least one wheel, in particular a rubber wheel.

According to a further aspect, the object mentioned at the outset is achieved by a method for operating a ground processing machine according to the invention, This method may include at least one of the following measures:
in the high-pressure drive state, the respective associated switching valve units of a first part of the hydraulic traction motors are switched to the high-pressure drive state switching position,
during the transition from the high-pressure drive state to a braking state of the electro-hydraulic drive system, at least some of the, preferably all, switching valve units of the first part of hydraulic traction motors are switched to the basic drive state switching position.

In order to be able to generate a sufficient drive torque in the high-pressure drive state, the method according to the invention can further provide that in a second part of the hydraulic traction motors the respectively assigned switching valve units are switched to the basic drive state switching position.

For a defined, even load distribution, for example on two axles or two sides of the ground processing machine, it can be provided that the first part of the hydraulic traction motors comprises half of the hydraulic traction motors of the ground processing machine. The second part of the hydraulic traction motors can then, for example, comprise the other half of the hydraulic traction motors of the ground processing machine.

Furthermore, the hydraulic traction motors of the first part of hydraulic traction motors can be assigned to at least one first drive roller of the ground processing machine that can rotate about a first axis of rotation, and/or the hydraulic traction motors of the second part of hydraulic traction motors can be assigned to at least one second drive roller of the ground processing machine that can rotate about a second axis of rotation. This means that in the high-pressure operating state, all active hydraulic traction motors can act on one axle.

For load distribution across two axles, some of the hydraulic traction motors of the first part of hydraulic traction motors can be assigned to at least one first drive roller of the ground processing machine that can rotate about a first axis of rotation, and some of the hydraulic traction motors of the second part of hydraulic traction motors can be assigned to at least one first drive roller of the ground processing machine that can rotate about the first axis of rotation, or/and some of the hydraulic traction motors of the first part of hydraulic traction motors can be assigned to at least one second drive roller of the ground processing machine that can rotate about a second axis of rotation, and some of the hydraulic traction motors of the second part of hydraulic traction motors can be assigned to at least one second drive roller of the ground processing machine that can rotate about the second axis of rotation.

The present invention is described in detail below with reference to the attached figures. In particular:

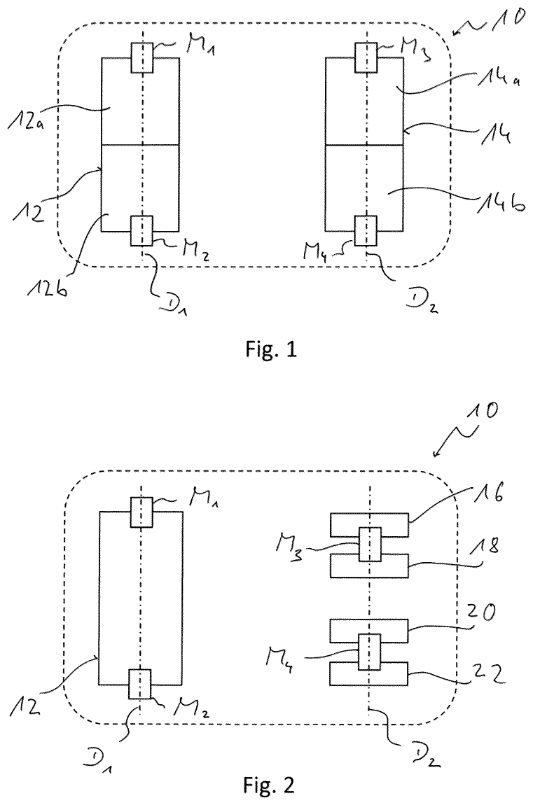

FIG. 1 shows a schematic representation of a ground processing machine with two ground processing rollers, each forming a drive roller;

FIG. 2 a representation corresponding to FIG. 1 of an alternatively designed ground processing machine in which a part of the drive rollers is formed by wheels;

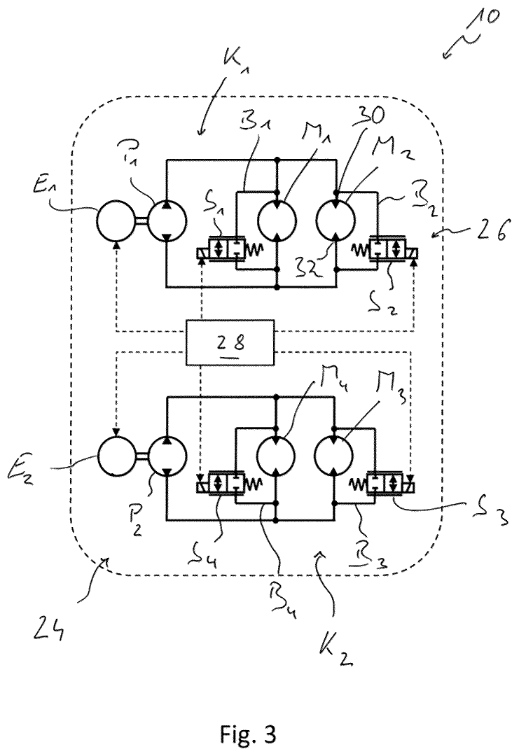

FIG. 3 shows an embodiment of an electro-hydraulic drive system for a ground processing machine with two hydraulic traction circuits;

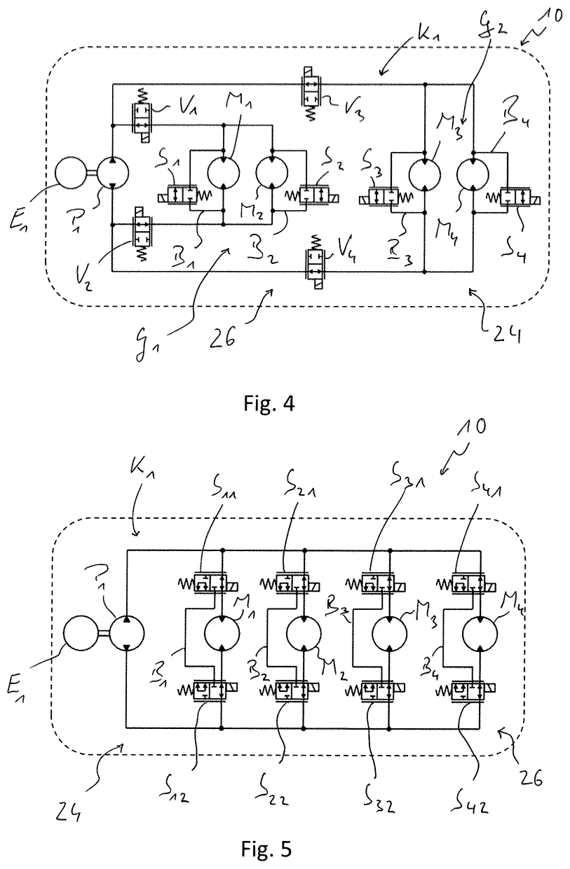

FIG. 4 shows an embodiment of an electro-hydraulic drive system for a ground processing machine with a single hydraulic traction circuit;

FIG. 5 shows a further embodiment of an electro-hydraulic drive system for a ground processing machine with a single hydraulic traction circuit.

In FIG. 1, a ground processing machine designed as a ground compactor is generally designated by 10. The ground processing machine 10 designed as a ground compactor comprises two drive rollers 12, 14 arranged one after the other in the longitudinal direction thereof and each designed as a ground processing roller. The drive roller 12 is rotatable about a first axis of rotation D₁, and the drive roller 14 is rotatable about a second axis of rotation D₂. Each of the two drive rollers 12, 14 is assigned two hydraulic traction motors M₁, M₂ or M₃, M₄. For example, the hydraulic traction motors M₁, M₂, M₃, M₄ assigned to a respective drive roller 12 or 14 can each be arranged at their axial ends.

The two drive rollers 12, 14 can, as illustrated in FIG. 1, be designed as segmented ground processing rollers with respective segments 12a, 12b and 14a, 14b. Each of the segments is assigned one of the four hydraulic traction motors M₁, M₂, M₃, M₄, so that the two segments 12a, 12b can be driven independently of one another by the hydraulic traction motors M₁, M₂ assigned to them to rotate about the axis of rotation D₁ and the two segments 14a, 14b can be driven independently of one another by the hydraulic traction motors M₃, M₄ assigned to them to rotate about the axis of rotation D₂. In principle, however, at least one of the two drive rollers 12, 14 could be designed as a ground processing roller which is intrinsically rigid and driven to rotate at its two axial ends by the respectively associated hydraulic traction motors.

FIG. 2 shows an alternative embodiment of such a ground processing machine 10, for example designed as a ground processing roller. The ground processing machine 10 of FIG. 2 comprises in one of its longitudinal end regions the drive roller 12 designed as a ground processing roller with the two hydraulic traction motors M₁, M₂ assigned to it. In this embodiment, too, the drive roller 12 can be designed as a ground processing roller which intrinsically rigid and driven to rotate at its two axial ends by the respectively associated hydraulic traction motors or can, as shown in FIG. 1, comprise two segments which can be driven independently of one another to rotate about the axis of rotation D₁ by a respectively associated hydraulic traction motor. In the other longitudinal end region of the ground processing machine 10, drive rollers 16, 18, 20, 22 designed as wheels are provided. These can, for example, be assigned to each other in pairs and each pair of wheels or drive rollers 16, 18 or 20, 22 can be driven in rotation by the associated hydraulic traction motor M₃ or M₄.

It is also to be noted that different embodiments of such ground processing machines can be used in the context of an electro-hydraulic drive system described in the following. For example, in the case of a ground processing machine designed as a ground compactor, a pair of drive wheels, each forming a drive roller, can be provided on a rear carriage, while a ground processing roller can act as a drive roller on the front carriage. The principles of the present invention can be applied to pivot-steered ground processing machines or ground compactors as well as to ground processing machines divided into front and rear carriages.

In FIG. 3, an electro-hydraulic drive system constructed according to the principles of the present invention, for example for a ground processing machine 10 shown in FIGS. 1 and 2, is generally designated by 24. In the exemplary embodiment shown, the electro-hydraulic drive system 24 comprises two hydraulic traction circuits K₁, K₂. The two hydraulic traction motors M₁, M₂ can be assigned to the hydraulic traction circuit K₁, and the two hydraulic traction motors M₃, M₄ can be assigned to the hydraulic traction circuit K₂.

The hydraulic traction circuit K₁ is also assigned a hydraulic traction pump P₁, which can be driven by an individually assigned electric drive motor E₁ for pumping fluid through the hydraulic traction circuit K₁ and the hydraulic traction motors M₁, M₂ arranged parallel to one another in the latter. Likewise, a hydraulic traction pump P₂ is assigned to the hydraulic traction circuit K₂. The hydraulic traction pump P₂ is driven by an electric drive motor E₂ assigned to it for pumping fluid through the hydraulic traction circuit K₂ and the hydraulic traction motors M₃, M₄ which are connected in parallel to one another and thus through which hydraulic fluid can flow.

A bypass flow path B₁, B₂, B₃, B₄ connected in parallel to each of the hydraulic traction motors M₁, M₂, M₃, M₄ is provided. A valve arrangement of the electro-hydraulic drive system, generally designated 26, comprises, in association with each of the four hydraulic traction motors M₁, M₂, M₃, M₄, a switching valve unit S₁, S₂, S₃, S₄ arranged in the respectively associated bypass flow path B₁, B₂, B₃, B₄.

Just like the two electric drive motors E₁, E₂, the switching valve units S₁, S₂, S₃, S₄ are controlled by a control unit generally designated 28. By means of the control unit 28, the switching valve units S₁, S₂, S₃, S₄ can be switched between a basic drive state switching position and a high-pressure drive state switching position. In the basic drive state switching position shown in association with each of the switching valve units S₁, S₂, S₃, S₄, the respectively associated bypass flow path B₁, B₂, B₃, B₄ is blocked off against the flow of hydraulic fluid, so that the hydraulic fluid conveyed by means of the respective hydraulic traction pump P₁ or P₂ through the respective hydraulic traction circuit K₁, K₂ flows through both hydraulic traction motors M₁, M₂, M₃, M₄ and therefore preferably the same drive torque is generated by all four hydraulic traction motors M₁, M₂, M₃, M₄.

In a high-pressure drive state switching position of the switching valve units S₁, S₂, S₃, S₄, the respectively assigned bypass flow path B₁, B₂, B₃, B₄ is released for the flow of hydraulic fluid, so that, provided the respectively assigned hydraulic traction pump P₁, P₂ is still operating, the hydraulic fluid delivered by the respective hydraulic traction pump P₁, P₂ is conveyed past the respectively assigned hydraulic traction motor M₁, M₂, M₃, M₄ due to the lower flow resistance and no drive torque is generated in a hydraulic traction motor M₁, M₂, M₃, M₄, whose assigned switching valve unit S₁, S₂, S₃, S₄ is set to the high-pressure operating state switching position. becomes. In principle, in the high-pressure drive state of the electro-hydraulic drive system 24 or when the switching valve units S₁, S₂ or S₃, S₄ are switched to the high-pressure drive state, the operation of the associated hydraulic traction pump P₁ or P₂ is not necessary. When the hydraulic traction pump P₁ or P₂ is deactivated, the hydraulic traction motors M₁, M₂ or M₃, M₄, driven by the respectively assigned drive roller rolling on the ground, circulate fluid between their fluid connections 30, 32 which are short-circuited via the respectively assigned bypass flow path B₁, B₂ or B₃, B₄.

It should be noted that the switching valve units S₁, S₂, S₃, S₄ can be designed, for example, as proportional valves, so that they can be switched between their two switching positions even during driving without switching shocks occurring. In a simpler design, these switching valve units S₁, S₂, S₃, S₄ can be designed as continuous valves or binary-acting valves that can only be switched between an open state and a closed state. In order to avoid switching shocks, it is advantageous to switch such valves between the two switching positions when they are at a standstill, i.e. without pressure.

In normal operation of the ground processing machine 10, designed for example as a ground compactor, or of the electro-hydraulic drive system 24 shown in FIG. 3, the two hydraulic traction pumps P₁, P₂ are driven by the associated electric drive motors E₁, E₂. The switching valve units S₁, S₂, S₃, S₄ are in their basic drive state switching position, in which they block the bypass flow paths B₁, B₂, B₃, B₄, so that the fluid delivered by the hydraulic traction pumps P₁, P₂ flows through the respectively assigned hydraulic traction motors M₁, M₂, M₃, M₄ and each of these hydraulic traction motors M₁, M₂, M₃, M₄ generates a part of the total drive torque. For example, the two hydraulic traction pumps P₁, P₂ can be designed as fixed displacement pumps, and the hydraulic traction motors M₁, M₂, M₃, M₄ can be designed as fixed displacement motors. A change in the driving state can then be brought about by appropriate control of the electric drive motors E₁, E₂ to change their speed and thus also the speed or delivery rate of the hydraulic traction pumps P₁, P₂.

If, for example, when the ground processing machine 10 is in a transfer journey between two construction sites, switching to the high-pressure drive state is required, the hydraulic traction motors M₃, M₄ assigned to the drive roller 14 can be deactivated. For this purpose, the switching valve units S₃, S₄ assigned to them are set to their high-pressure drive state switching position, in which they release the respectively assigned bypass flow path B₃, B₄ for flow-through. At the same time, the hydraulic traction pump P₂ can be deactivated so that no fluid is pumped through the fluid circuit K₂. The hydraulic traction motors M₃, M₄ are short-circuited via the open bypass flow paths assigned to them, so that they can rotate with the rolling drive roller 14 and can circulate fluid via the bypass flow path B₃ or B₄, which creates a flow short circuit. Alternatively, in this state it is also possible to continue operating the hydraulic traction pump P₂ in order to prevent blocking of the hydraulic traction motors M₃, M₄ and the resulting possible dragging of the drive roller 14 over the ground.

In this high-pressure drive state of the electro-hydraulic drive system 24, the entire drive torque is then generated by the hydraulic traction motors M₁, M₂ of the hydraulic traction circuit K₁ fed by the hydraulic traction pump P₁. The higher fluid pressure required for this in the hydraulic traction circuit K₁ is generated by a correspondingly higher drive power of the electric drive motor E₁. Due to the fact that in this state the hydraulic traction circuit K₁ operates with a fluid pressure which is essentially twice the fluid pressure in the basic drive state, the hydraulic traction motors M₁, M₂ are operated with significantly higher efficiency, which more than compensates for the energy losses generated by the circulation of fluid by the dragged hydraulic traction motors M₃, M₄.

In order to be able to generate a sufficient braking torque when driving downhill, for example, the hydraulic traction circuit K₂ of the initially non-driven drive roller 14 can be reactivated when changing to a braking state from the high-pressure drive state. For this purpose, the switching valve units S₃, S₄ are switched to their basic drive state switching position, so that in the braking state a braking torque is generated by the hydraulic traction motors M₃, M₄ driven by the drive roller 14 or the hydraulic traction pump P₁, which can also be used, for example, to feed electrical energy back via the electric drive motor E₂ which is then operated as a generator.

In the electro-hydraulic drive system 24 shown in FIG. 3, various structural variations or operational variations can be provided. While in the high-pressure drive state described above a drive roller or, if applicable, the segments of a drive roller or ground processing roller that can rotate about the same axis of rotation are used to generate the drive torque, it is also possible to distribute the drive torque to both drive rollers 12, 14. For this purpose, it is necessary to assign a respective hydraulic traction motor to one of the two drive rollers and a hydraulic traction motor to the other drive roller in the hydraulic traction circuits K₁, K₂. The two hydraulic traction motors M₁, M₄ can be assigned to the hydraulic traction circuit K₁, and the two hydraulic traction motors M₂, M₃ can be assigned to the hydraulic traction circuit K₂. In the high-pressure drive state, one of the hydraulic traction motors acting in relation to one of the rotation axes can generate a drive torque, while the other hydraulic traction motor assigned to the same rotation axis is dragged along. Such an arrangement is particularly advantageous if the drive rollers 12, 14 are not segmented but are designed as rigid ground processing rollers. In principle, however, it is also possible to work with drive rollers 12, 14 divided into segments with such a drive effect divided into segments assigned to the various axes of rotation.

In the ground processing machine 10 shown in FIG. 3 or in the electro-hydraulic drive system 24 shown in FIG. 3, for example, only one of the two hydraulic traction circuits K₁, K₂ could be switchable between the basic drive state and the high-pressure drive state, while the other hydraulic traction circuit is then also used in the high-pressure drive state of the electro-hydraulic drive system 24 to generate the drive torque. Furthermore, the hydraulic traction circuits K₁, K₂ could be designed with regard to the valve arrangement 26 such that, in association with the hydraulic traction motors M₁, M₂ or M₃, M₄ connected in parallel in pairs, it comprises only one bypass flow path used jointly by these and therefore also only a single switching valve unit.

An alternative embodiment of an electro-hydraulic drive system 24 is shown in FIG. 4. This electro-hydraulic drive system 24 comprises only one single hydraulic traction circuit K₁ with a single hydraulic traction pump P₁ and an electric drive motor E₁ assigned to it. The four hydraulic traction motors M₁, M₂, M₃, M₄ are divided into two groups G₁, G₂. Group G₁ comprises the hydraulic traction motors M₁, M₂, and group G₂ comprises the hydraulic traction motors M₃, M₄. In each group G₁, G₂, the hydraulic traction motors M₁, M₂ and M₃, M₄ are connected in parallel to each other, and the two groups G₁, G₂ are fed with fluid in parallel to each other by the hydraulic traction pump P₁.

In association with each of the hydraulic traction motors M₁, M₂ or M₃, M₄, a parallel bypass flow path B₁, B₂, B₃, B₄ is provided, each with a switching valve unit S₁, S₂, S₃, S₄ provided therein. Here too, in conjunction with the hydraulic traction motors M₁, M₂ or M₃, M₄ provided in pairs in a group G₁, G₂, only one jointly used bypass flow path with a single switching valve unit could be provided.

The valve arrangement 26 further comprises two shut-off valve units V₁, V₂ and V₃, V₄, respectively, associated with each of the two groups G₁, G₂. The shut-off valve units V₁, V₂, V₃, V₄, which are also designed as proportional valves, for example, are arranged in the flow direction on both sides of the respectively assigned pair of hydraulic traction motors M₁, M₂ or M₃, M₄ and, like the switching valve units S₁, S₂, S₃, S₄, are controlled by the control unit 28 shown in FIG. 3.

In the basic drive state, the shut-off valve units V₁, V₂, V₃, V₄ are in the basic drive state switching position shown in FIG. 4, in which they release the fluid supply to all hydraulic traction motors M₁, M₂, M₃, M₄. The switching valve units S₁, S₂, S₃, S₄ are also in the basic drive state switching position and therefore close the bypass flow paths B₁, B₂, B₃, B₄.

If the high-pressure drive state is to be switched to and, for example, the hydraulic traction motors M₁, M₂ of group G₁ are to be used to generate the drive torque, the shut-off valve units V₁, V₂ and switching valve units S₁, S₂ assigned to them remain in the basic drive state switching position. The shut-off valve units V₃, V₄ and switching valve units S₃, S₄ assigned to the hydraulic traction motors M₃, M₄ of group G₂ are switched to the high-pressure drive state switching position, in which on the one hand the supply of fluid to the hydraulic traction motors M₃, M₄ is prevented by the shut-off valve units V₃, V₄ and on the other hand the bypass flow paths B₃, B₄ are released for flow through by the switching valve units S₃, S₄ provided therein. The hydraulic traction motors M₃, M₄ are then dragged along by the drive roller assigned to them and can circulate fluid via the respectively assigned bypass flow path B₃, B₄.

In this type of design of an electro-hydraulic drive system 24, too, by selecting the assignment of the various hydraulic traction motors M₁, M₂, M₃, M₄ to the two groups G₁, G₂ in the high-pressure drive state, the drive torque can be transmitted either to a drive roller or two segments of a drive roller that can rotate about the same axis of rotation, while no drive torque is generated on the other axis, or a part of the drive torque can be generated on each of the two axes, for example on segmented drive rollers or intrinsically rigid drive rollers.

Another alternative embodiment of an electro-hydraulic drive system 24 is shown in FIG. 5. This electro-hydraulic drive system 24 also comprises only one single hydraulic traction circuit K₁ with a single hydraulic traction pump P₁. The four hydraulic traction motors M₁, M₂, M₃, M₄ are connected in parallel to each other and are fed with fluid in parallel by the hydraulic traction pump P₁.

The valve arrangement 26 comprises, in association with each hydraulic traction motor M₁, M₂, M₃, M₄ or in association with each bypass flow path B₁, B₂, B₃, B₄, two switching valve units S₁₁, S₁₂, S₂₁, S₂₂, S₃₁, S₃₂, S₄₁, S₄₂ positioned in the flow direction on both sides of the respectively associated hydraulic traction motor M₁, M₂, M₃, M₄. In the basic drive state switching position of the switching valve units S₁₁, S₁₂, S₂₁, S₂₂, S₃₁, S₃₂, S₄₁, S₄₂ shown in FIG. 5, the bypass flow paths B₁, B₂, B₃, B₄ interacting with them are blocked off, so that the fluid connections 30, 32 of the hydraulic traction motors M₁, M₂, M₃, M₄ are open to receive fluid delivered by the hydraulic traction pump P₁ or are open to discharge fluid in the direction of the hydraulic traction pump P₁.

When transitioning to the high-pressure drive state, the associated pair of switching valve units S₁₁, S₁₂ or S₂₁, S₂₂ or S₃₁, S₃₂ or S₄₁, S₄₂ of at least one of the hydraulic traction motors M₁, M₂, M₃, M₄ can be brought into the high-pressure drive state switching position, in which the fluid connections 30, 32 of the associated hydraulic traction motor M₁, M₂, M₃, M₄ are decoupled from the hydraulic traction pump P₁ or from the hydraulic traction circuit K₁ and are connected to the associated bypass flow path B₁, B₂, B₃, B₄. Each hydraulic traction motor M₁, M₂, M₃, M₄ not used to generate a drive torque in the high-pressure drive state can then circulate fluid via the associated bypass flow path B₁, B₂, B₃, B₄.

In the type of embodiment shown in FIG. 5, any of the hydraulic traction motors M₁, M₂, M₃, M₄ can be used to generate a drive torque or deactivated, so that in the high-pressure drive state, for example, only a single hydraulic traction motor is used to drive the ground processing machine 10 or, if necessary, three of the four hydraulic traction motors can be used to generate a drive torque.

In order to be able in this embodiment to switch between the different drive states during the forward movement of the ground processing machine 10 and to enable the switching on of hydraulic traction motors to generate a braking torque when the ground processing machine 10 is operated in the high-pressure drive state, the switching valve units S₁₁, S₁₂, S₂₁, S₂₂, S₃₁, S₃₂, S₄₁, S₄₂ can be designed as proportional valves which enable a gradual transition when switching between the different switching states, avoiding switching shocks.

It should also be noted that the present invention can also be applied to an electro-hydraulic drive system for a ground processing machine with only two hydraulic traction motors, for example each associated with two undivided ground processing rollers. In the high-pressure drive state, only one of the two hydraulic traction motors can be fed with fluid at a correspondingly increased pressure, while no fluid is fed to the other hydraulic traction motor.

1. An electro-hydraulic drive system for a ground processing machine with at least one drive roller, the system comprising:
at least one hydraulic traction pump drivable by a drive electric motor for pumping hydraulic fluid,
at least two hydraulic drive motors to be fed with hydraulic fluid by the at least one hydraulic drive pump,
a valve arrangement,
a control unit for operating the valve arrangement such that in a basic drive state of the electro-hydraulic drive system each hydraulic traction motor is fed with hydraulic fluid from the at least one hydraulic traction pump to generate a drive torque and in a high-pressure drive state of the electro-hydraulic drive system at least one hydraulic traction motor is not fed with hydraulic fluid from the at least one hydraulic traction pump to generate a drive torque.

2. The electro-hydraulic drive system according to claim 1,
wherein at least one hydraulic circuit is provided with at least two hydraulic traction motors fed in parallel with hydraulic fluid from at least one hydraulic traction pump, and in that the valve arrangement comprises at least one switching valve unit in association with the at least two hydraulic traction motors of at least one hydraulic traction circuit.

3. The electro-hydraulic drive system according to claim 2,
wherein when the at least one switching valve unit assigned to a hydraulic traction motor is switched to a basic drive state switching position, this hydraulic traction motor is fed with hydraulic fluid delivered by the at least one hydraulic traction pump to generate a drive torque, and when the at least one switching valve unit assigned to a hydraulic traction motor is switched to a high-pressure drive state switching position, a bypass flow path assigned to this hydraulic traction motor and parallel thereto is open for flow and/or creates a flow short circuit between two fluid connections of the hydraulic traction motor.

4. The electro-hydraulic drive system according to claim 2,
wherein at least two hydraulic traction circuits are provided, wherein each hydraulic traction circuit is assigned a hydraulic traction pump and at least two hydraulic traction motors fed in parallel with hydraulic fluid by the hydraulic traction pump.

5. The electro-hydraulic drive system according to claim 4,
wherein each hydraulic traction pump is assigned an electric drive motor.

6. The electro-hydraulic drive system according to claim 4,
wherein when the at least one switching valve unit assigned to a hydraulic traction motor is switched to a basic drive state switching position, this hydraulic traction motor is fed with hydraulic fluid delivered by the at least one hydraulic traction pump to generate a drive torque, and when the at least one switching valve unit assigned to a hydraulic traction motor is switched to a high-pressure drive state switching position, a bypass flow path assigned to this hydraulic traction motor and parallel thereto is open for flow and/or creates a flow short circuit between two fluid connections of the hydraulic traction motor, and
wherein the valve arrangement in each of the hydraulic traction circuits in association with each hydraulic traction motor comprises a switching valve unit which blocks the bypass flow path parallel to this in the basic drive state switching position and releases it for flow-through in the high-pressure drive state switching position.

7. The electro-hydraulic drive system according to claim 2,
wherein at least one hydraulic traction circuit is provided, wherein the at least one hydraulic traction circuit is assigned a hydraulic traction pump and at least two hydraulic traction motors fed in parallel with hydraulic fluid by the hydraulic traction pump.

8. The electro-hydraulic drive system according to claim 7,
wherein when the at least one switching valve unit assigned to a hydraulic traction motor is switched to a basic drive state switching position, this hydraulic traction motor is fed with hydraulic fluid delivered by the at least one hydraulic traction pump to generate a drive torque, and when the at least one switching valve unit assigned to a hydraulic traction motor is switched to a high-pressure drive state switching position, a bypass flow path assigned to this hydraulic traction motor and parallel thereto is open for flow and/or creates a flow short circuit between two fluid connections of the hydraulic traction motor, and
wherein the valve arrangement in association with each hydraulic traction motor comprises a switching valve unit which blocks the bypass flow path parallel to this in the basic drive state switching position and releases it for flow-through in the high-pressure drive state switching position.

9. The electro-hydraulic drive system according to claim 7,
wherein the hydraulic traction motors form at least two hydraulic traction motor groups fed in parallel by the hydraulic traction pump, each with at least two hydraulic traction motors fed in parallel by the hydraulic traction pump, wherein the valve arrangement in association with each hydraulic traction motor group has at least one shut-off valve unit for selectively blocking this hydraulic traction motor group against the supply of hydraulic fluid delivered by the hydraulic traction pump and releasing this hydraulic traction motor group for supplying hydraulic fluid pumped by the hydraulic traction pump.

10. The electro-hydraulic drive system according to claim 9,
wherein the valve arrangement in association with each hydraulic traction motor group comprises two shut-off valve units arranged in the fluid flow direction on both sides of this hydraulic traction motor group.

11. The electro-hydraulic drive system according to claim 7,
wherein when the at least one switching valve unit assigned to a hydraulic traction motor is switched to a basic drive state switching position, this hydraulic traction motor is fed with hydraulic fluid delivered by the at least one hydraulic traction pump to generate a drive torque, and when the at least one switching valve unit assigned to a hydraulic traction motor is switched to a high-pressure drive state switching position, a bypass flow path assigned to this hydraulic traction motor and parallel thereto is open for flow and/or creates a flow short circuit between two fluid connections of the hydraulic traction motor, and
wherein the valve arrangement, in associate with each hydraulic traction motor (M₁, M₂, M₃, M₄), comprises two switching valve units associated with each hydraulic traction motor wherein in the basic drive state switching position the switching valve units associated with a respective hydraulic traction motor release the supply of hydraulic fluid delivered by the hydraulic traction pump to this hydraulic traction motor and, in the high-pressure drive state switching position, release the bypass flow path parallel to this hydraulic traction motor to generate the flow short circuit between the fluid connections of this hydraulic traction motor.

12. The electro-hydraulic drive system according to claim 2,
wherein at least one switching valve unit comprises a proportional valve.

13. A ground processing machine, comprising a plurality of drive rollers and an electro-hydraulic drive system according to claim 1.

14. The ground processing machine according to claim 13,
wherein at least one drive roller comprises a ground processing roller, and/or that at least one drive roller comprises at least one wheel.

15. A method for operating a ground processing machine according to claim 13,
wherein at least one hydraulic circuit is provided with at least two hydraulic traction motors fed in parallel with hydraulic fluid from at least one hydraulic traction pump, and in that the valve arrangement comprises at least one switching valve unit in association with the at least two hydraulic traction motors of at least one hydraulic traction circuit.
wherein when the at least one switching valve unit assigned to a hydraulic traction motor is switched to a basic drive state switching position, this hydraulic traction motor is fed with hydraulic fluid delivered by the at least one hydraulic traction pump to generate a drive torque, and when the at least one switching valve unit assigned to a hydraulic traction motor is switched to a high-pressure drive state switching position, a bypass flow path assigned to this hydraulic traction motor and parallel thereto is open for flow and/or creates a flow short circuit between two fluid connections of the hydraulic traction motor, and
wherein the method comprises at least one of the following measures:
in the high-pressure drive state, the respective associated switching valve units of a first part of the hydraulic traction motors are switched to the high-pressure drive state switching position,
during the transition from the high-pressure drive state to a braking state of the electro-hydraulic drive system, at least some of switching valve units of the first part of hydraulic traction motors are switched to the basic drive state switching position.

16. The method according to claim 15,
wherein in the high-pressure drive state, in a second part of the hydraulic traction motors the respectively associated switching valve units are switched to the basic drive state switching position.

17. The method according to claim 15,
wherein the first part of the hydraulic traction motors comprises half of the hydraulic traction motors of the ground processing machine.

18. The method according to claim 15,
wherein the hydraulic traction motors of the first part of hydraulic traction motors are assigned to at least one first drive roller of the ground processing machine which is rotatable about a first axis of rotation.

19. The method according to claim 18,
wherein the hydraulic traction motors of a second part of hydraulic traction motors are assigned to at least one second drive roller of the ground processing machine which is rotatable about a second axis of rotation.

20. The method according to claim 16,
wherein a part of the hydraulic traction motors of the first part of hydraulic traction motors is assigned to the at least one first drive roller of the ground processing machine that is rotatable about a first axis of rotation and a part of the hydraulic traction motors of the second part of hydraulic traction motors is assigned to at least one first drive roller of the ground processing machine that is rotatable about the first axis of rotation, or/and that a part of the hydraulic traction motors of the first part of hydraulic traction motors is assigned to at least one second drive roller of the ground processing machine which is rotatable about a second axis of rotation and a part of the hydraulic traction motors of the second part of hydraulic traction motors is assigned to the at least one second drive roller of the ground processing machine which is rotatable about the second axis of rotation.
